(19) United States
(12) Patent Application Publication
(10) Pub. No.: US 2012/0007906 A1
(43) Pub. Date: Jan. 12, 2012

(54) LIQUID EJECTING APPARATUS AND CONTROL METHOD

(75) Inventor: Junhua Zhang, Shiojiri-shi (JP)

(73) Assignee: SEIKO EPSON CORPORATION, Shinjuku-ku (JP)

(21) Appl. No.: 13/180,446

(22) Filed: Jul. 11, 2011

(30) Foreign Application Priority Data
Jul. 12, 2010 (JP) 2010-157636

(51) Int. Cl. B41J 29/38

(52) U.S. Cl. 347/14

(57) ABSTRACT

A liquid ejecting apparatus includes: a liquid ejecting head that includes nozzle openings through which liquid is ejected and pressure generation units that cause changes in pressure of the liquid inside pressure generation chambers communicating with the nozzle openings; a control unit that supplies a driving signal for causing the liquid ejecting head to eject the liquid, to the pressure generation units, and controls ejection of the liquid by the liquid ejecting head; and a temperature detection unit that detects a temperature of a contact portion with which the liquid ejected by the liquid ejecting head comes in contact, wherein the control unit corrects the driving signal on the basis of the temperature information detected by the temperature detection unit.

### BACKGROUND

1. Technical Field

The present invention relates to a liquid ejecting apparatus including a liquid ejecting head that ejects liquid and a control method, and more particularly, to an ink jet recording apparatus including an ink jet recording head that discharges ink as liquid and a control method.

2. Related Art

A liquid ejecting apparatus represented by an ink jet recording apparatus such as an ink jet printer or a plotter has a liquid ejecting head capable of discharging liquid from a liquid storage unit such as a cartridge or a tank that stores the liquid as liquid droplets.

Here, the liquid ejecting head includes pressure generation chambers that communicate with nozzle openings and pressure generation units that cause changes in the pressure of the liquid inside the pressure generation chambers to discharge liquid droplets from the nozzle openings. In addition, as the pressure generation unit mounted in the liquid ejecting head, for example, a longitudinal vibration-type piezoelectric element, a flexural vibration-type piezoelectric element, a heat generating element, a device that uses electrostatic force, or the like may be employed.

The liquid discharged from the liquid ejecting head has a viscosity suitable for discharge depending on the type of liquid. Since the viscosity of a liquid has a correlation with temperature, a liquid has properties of increasing viscosity as the temperature reduces and of reducing viscosity as the temperature increases. Accordingly, a driving signal for driving the pressure generation unit of the liquid ejecting head needs to be corrected depending on the viscosity that changes with the liquid temperature (for example, refer to JP-A-6-31934 and JP-A-2009-56669).

However, measurement of the temperature of liquid is performed by measuring an ambient temperature (atmospheric temperature) of the liquid ejecting head using a sensor, so that an error between the temperature of the liquid inside the pressure generation chamber immediately before being discharged from the liquid ejecting head and the ambient temperature occurs. Therefore, even though the driving signal is corrected on the basis of the ambient temperature, the driving signal cannot be corrected to be optimal to the actual liquid viscosity, and the discharge characteristics are degraded, so that there is a problem in that print quality is deteriorated.

In addition, disposing a temperature sensor inside each pressure generation chamber of the liquid ejecting head or inside a flow path of a liquid chamber or the like common to the pressure generation chambers may be considered. However, it is difficult to provide the temperature sensor inside the flow path of the pressure generation chamber or the like due to an increase in the density of the liquid ejecting head and a reduction in size thereof, and there is a problem in that as the temperature sensor is provided, the size of the liquid ejecting head is increased, resulting in an increase in costs. In addition, providing a temperature sensor in the common liquid chamber, a liquid storage unit, or the like may be considered. However, there are problems in that an error occurs between the temperature of the liquid immediately before being discharged and the temperature of the liquid in the liquid chamber or the liquid storage unit on the upstream side thereof, and the driving signal cannot be corrected to be optimal to the viscosity of the actually discharged liquid, resulting in degradation of the discharge characteristics and deterioration of print quality.

In addition, these problems are not limited to only the ink jet recording apparatus but also exist in liquid ejecting apparatuses that eject liquids other than ink.

### SUMMARY

An advantage of some aspects of the invention is that it provides a liquid ejecting apparatus and a control method capable of enhancing liquid ejection characteristics and print quality without causing increases in size and costs of a liquid ejecting head.

According to an aspect of the invention, there is provided a liquid ejecting apparatus including: a liquid ejecting head that includes nozzle openings through which liquid is ejected and pressure generation units that cause changes in the pressure of the liquid inside pressure generation chambers communicating with the nozzle openings; a control unit that supplies a driving signal for causing the liquid ejecting head to eject the liquid, to the pressure generation units, and controls ejection of the liquid by the liquid ejecting head; and a temperature detection unit that has a contact portion with which the liquid ejected by the liquid ejecting head comes in contact and detects a temperature of the contact portion, wherein the control unit corrects the driving signal on the basis of the temperature information detected by the temperature detection unit.

In this aspect, since the temperature of the liquid droplet discharged from the liquid ejecting head is detected, a temperature sensor or the like does not need to be provided in the flow path of the liquid ejecting head, and a temperature sensor does not need to be provided in each of the liquid ejecting heads, thereby suppressing increases in the size and costs of the liquid ejecting heads. Since the temperature detection unit detects the temperature of the actually discharged liquid droplet, the driving signal can be corrected to be optimal to the actual liquid temperature, and therefore discharge characteristics of the discharged liquid droplets can be uniformized regardless of temperature changes.

Here, the control unit may correct the driving signal so as to apply a higher voltage than a reference voltage applied to the pressure generation unit by the driving signal, when the detected temperature information represents a temperature lower than a reference temperature, and the controller may correct the driving signal so as to apply a lower voltage than the reference voltage applied to the pressure generation unit by the driving signal, when the detected temperature information represents a temperature higher than the reference temperature. Accordingly, liquid droplets can always be ejected with uniform discharge characteristics regardless of the liquid temperature, so that print quality can be enhanced.

In addition, it is preferable that an ambient temperature detection unit that measures the atmospheric temperature of the liquid ejecting head be further included, and the control unit correct the temperature information using the difference between the temperature information detected by the temperature detection unit and ambient temperature information detected by the ambient temperature detection unit, and correct the driving signal on the basis of the corrected temperature information. Accordingly, the correction is performed by measuring the room temperature (atmospheric temperature) which is the ambient temperature, and thus the actual liquid temperature can be acquired. Therefore, the driving signal can be corrected to be optimal to the actual liquid temperature, thereby further uniformizing the liquid ejection characteristics.

In addition, it is preferable that the contact portion be provided with a water-repellent film that repels the liquid ejected from the liquid ejecting head. Accordingly, since liquid adhering to the contact portion can be easily removed, adhesion of extra liquid is suppressed, and thus precision of the temperature detection which is repeatedly performed by the temperature detection unit can be enhanced.

In addition, it is preferable that the liquid ejecting head eject a liquid having a viscosity of 8 mPa·s or higher. Accordingly, particularly, since the liquid having a relatively high viscosity (of 8 mPa·s or higher) varies significantly in viscosity with a temperature difference of 1° C., the discharge characteristics of the liquid ejecting head that ejects the liquid having a relatively high viscosity (of 8 mPa·s or higher) can be uniformized regardless of changes in temperature.

According to another aspect of the invention, there is provided a control method of controlling a liquid ejecting head which includes nozzle openings through which liquid is ejected, pressure generation chambers communicating with the nozzle openings, and pressure generation units that cause changes in pressure of the liquid inside pressure generation chambers, including: detecting a temperature of the liquid ejected by the liquid ejecting head; and correcting a driving signal of the pressure generation unit of the liquid ejecting head on the basis of the detected temperature information.

In this aspect, since the temperature of the liquid droplet discharged from the liquid ejecting head is detected, a temperature sensor or the like does not need to be provided in a flow path of the liquid ejecting head, and a temperature sensor does not need to be provided in each of the liquid ejecting heads, thereby suppressing increases in the size and costs of the liquid ejecting heads. Since the temperature detection unit detects the temperature of the actually discharged liquid droplets, the driving signal can be corrected to be optimal to the actual liquid temperature, and therefore discharge characteristics of the discharged liquid droplets can be uniformized regardless of temperature changes.

### BRIEF DESCRIPTION OF THE DRAWINGS

The invention will be described with reference to the accompanying drawings, wherein like numbers reference like elements.

FIG. 1 is a schematic perspective view of a recording apparatus according to a first embodiment of the invention.

FIG. 2 is a perspective view of the main part of the recording apparatus according to the first embodiment of the invention.

FIG. 3 is a cross-sectional view of a recording head according to the first embodiment of the invention.

FIG. 4 is a block diagram showing a control configuration according to the first embodiment of the invention.

FIG. 5 is a block diagram showing the control configuration according to the first embodiment of the invention.

FIG. 6 is a graph showing a relationship between actual ink temperature, detected temperature, and room temperature.

FIGS. 7A to 7C are driving waveform diagrams showing driving signals according to the first embodiment of the invention.

FIGS. 8A to 8C are driving waveform diagrams showing driving signals according to the first embodiment of the invention.

FIGS. 9A to 9C are driving waveform diagrams showing driving signals according to the first embodiment of the invention.

FIG. 10 is a flowchart showing a control method according to the first embodiment of the invention.

### DESCRIPTION OF EXEMPLARY EMBODIMENTS

Hereinafter, exemplary embodiments of the invention will be described in detail with reference to the accompanying drawings.

### First Embodiment

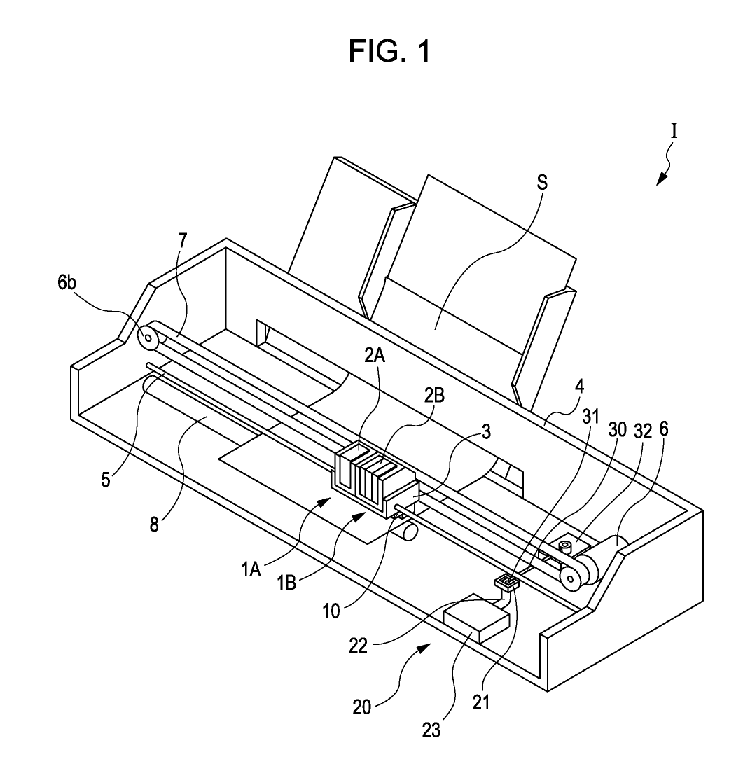

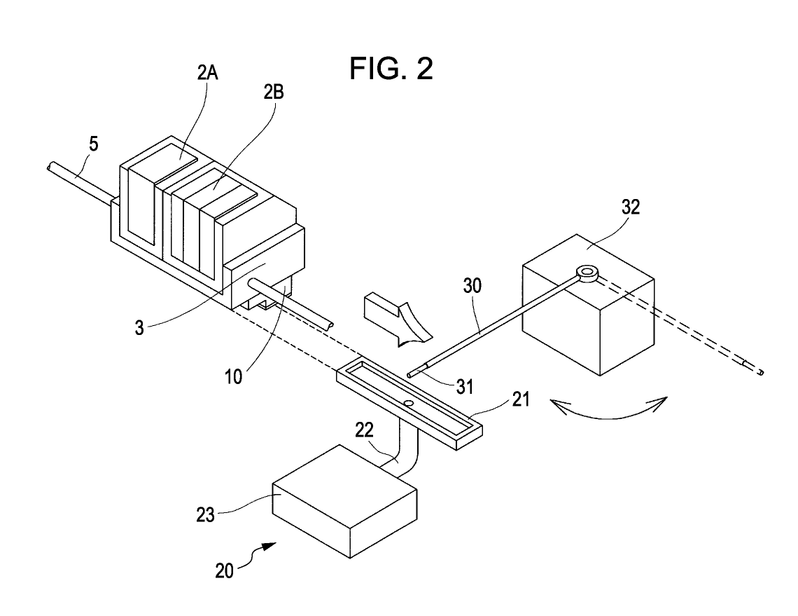

FIG. 1 is a schematic perspective view showing an ink jet recording apparatus which is an example of a liquid ejecting apparatus according to a first embodiment of the invention, and FIG. 2 is a perspective view of the main part of the ink jet recording apparatus.

As shown in FIG. 1, the ink jet recording apparatus I has head units 1A and 1B each of which includes an ink jet recording head 10. The ink jet recording heads 10 are provided with cartridges 2A and 2B that constitute an ink supply unit and are detachable, and a carriage 3 in which the head units 1A and 1B are mounted is provided on a carriage shaft 5 mounted in an apparatus body 4 so as to be movable in a main scanning direction which is the axial direction. The head units 1A and 1B discharge, for example, a black ink composition and a color ink composition, respectively.

In addition, as the driving force of a driving motor 6 is transmitted to the carriage 3 via a plurality of gears (not shown) and a timing belt 7, the carriage 3 in which the head units 1A and 1B are mounted is moved along the carriage shaft 5 (the main scanning direction). In this embodiment, the head units 1A and 1B are arranged in parallel along the main scanning direction which is the movement direction of the carriage 3.

On the other hand, a platen 8 is provided in the apparatus body 4 along the carriage shaft 5, such that a recording sheet S which is a recording medium such as a sheet of paper fed by a feed roller (not shown) or the like is wound around the platen 8 and is thus transported in a sub-scanning direction intersecting the main scanning direction.

In this ink jet recording apparatus I, when the cartridges 2A and 2B are mounted initially or replaced, bubbles remain in flow paths due to bubbles contained in the ink during a printing operation, and the bubbles absorb changes in pressure of the flow paths (particularly, pressure generation chambers which will be described later), so that the discharge of ink droplets cannot be normally performed and there is concern of printing failures such as dot omission. Therefore, in a non-printing region of the ink jet recording apparatus I, a suction unit 20 that suctions bubbles along with ink inside the flow paths from nozzle openings which will be described later is provided.

The suction unit 20 includes, as shown in FIG. 2, a cap member 21 that covers the nozzle openings of the ink jet recording head 10, and a suction device 23 such as a vacuum pump which is connected to the cap member 21 with a tube 22.

The cap member 21 is provided to oppose a discharge surface of the ink jet recording head 10 from which the ink is discharged. The cap member 21 is provided to have a size to cover all of the plurality of nozzle openings.

The suction unit 20 having the above configuration causes the cap member 21 to abut on the discharge surface of the ink jet recording head 10 and then causes the suction device 23 to perform a suction operation so that the inside of the cap member 21 reaches a negative pressure, thereby performing the suction operation of suctioning the ink along with the bubbles inside the flow paths from the nozzle openings.

In addition, the apparatus body 4 is provided with a temperature detection unit 30 having a contact portion 31 with which ink droplets discharged from the ink jet recording head 10 come in contact.

The temperature detection unit 30 detects the temperature of the contact portion 31 provided in the tip end portion, and may use, for example, a contact temperature sensor such as a thermoresistor, a thermocouple, or a thermistor.

The temperature detection unit 30 is provided so that the contact portion 31 is disposed at a position opposing the nozzle openings of the ink jet recording head 10 when the ink jet recording head 10 is moved to the non-printing region by the movement of the carriage 3. Specifically, the contact portion 31 of the temperature detection unit 30 is disposed between the ink jet recording head 10 and the cap member 21 when the ink jet recording head 10 is moved to the position opposing the cap member 21. Accordingly, ink droplets discharged from the ink jet recording head 10 adhere to the contact portion 31, so that the ink adhering to the contact portion 31 drops on the cap member 21 under its own weight, so that it is possible to prevent the inside of the apparatus body 4 from being stained by the ink.

In addition, the base end portion side of the temperature detection unit 30 which is the opposite side to the contact portion 31 is held by a holding member 32 to be rotatable. By the holding member 32, the contact portion 31 of the temperature detection unit 30 is movable from a position between the ink jet recording head 10 and the cap member 21 to outside this position. That is, when the temperature of ink droplets discharged from the ink jet recording head 10 is detected, the contact portion 31 of the temperature detection unit 30 is moved to a region opposing the nozzle openings, and ink droplets are discharged by the ink jet recording head 10. In addition, when the discharge surface of the ink jet recording head 10 is covered by the cap member 21, the contact portion 31 of the temperature detection unit 30 is moved outside the region between the cap member 21 and the ink jet recording head 10 by the holding member 32, so that it is possible to prevent the contact portion 31 from inhibiting capping of the ink jet recording head 10 by the cap member 21.

In addition, in this embodiment, the contact portion 31 is movable so that the ink adhering to the contact portion 31 is recovered by the cap member 21. However, the embodiment is not particularly limited thereto, and a temperature detection unit 30 having a contact portion 31 outside the cap member 21 may also be provided. In this case, an ink receptor that recovers the ink adhering to the contact portion 31 may be provided separately from the cap member 21.

In addition, since ink droplets discharged from the ink jet recording head 10 adhere to the contact portion 31 and the ink adhering to the contact portion 31 needs to drop into the cap member 21 under its own weight, it is preferable that the surface of the contact portion 31 be provided with a water-repellent film having water repellency. In addition, as the water-repellent film, for example, a metal film including fluorinated polymer, a molecular film of a metal alkoxide having liquid repellency, or the like may be used. As the water-repellent film is provided on the surface of the contact portion 31 as described above, the ink adhering to the contact portion 31 easily drops and subsequent temperature detection of ink droplets can be easily performed.

Moreover, the contact portion 31 may be provided to come in contact with ink droplets discharged from all the nozzle openings of the ink jet recording head, or be provided to come in contact with ink droplets discharged from a plurality of nozzle openings 12 of the ink jet recording head 10 which are selected at predetermined intervals. When the ink droplets discharged from all the nozzle openings 12 of the ink jet recording head 10 adhere to the contact portion 31, a highly precise temperature, which is an average of the temperatures of the ink droplets, can be acquired. In addition, a temperature gradient of rows in which the nozzle openings 12 are arranged in parallel or the like can be acquired. In addition, a driving signal corresponding to each nozzle opening 12 or each nozzle opening group constituted by a plurality of the nozzle rows 12 may be selected.

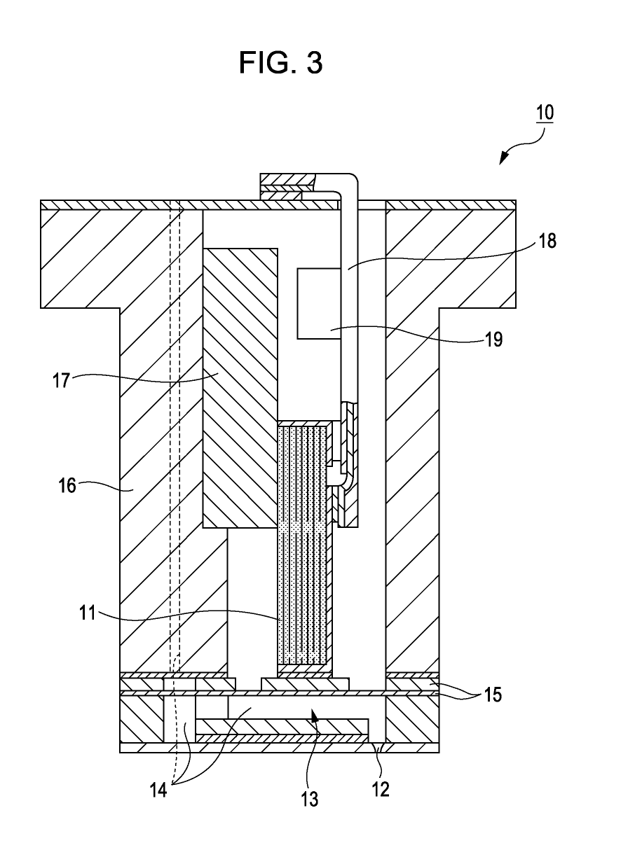

Here, the ink jet recording head 10 will be described with reference to FIG. 3. FIG. 3 is a cross-sectional view of the ink jet recording head which is an example of a liquid ejecting head according to the first embodiment of the invention.

As shown in FIG. 3, the ink jet recording head 10 includes a pressure generation chamber 13 communicating with the nozzle opening 12 that ejects ink droplets, flow paths 14 that cause the pressure generation chamber 13 to communicate with liquid storage units such as the above-mentioned cartridges 2A and 2B, a vibrating plate 15 provided to oppose the pressure generation chamber 13, and a piezoelectric element 11 which is a pressure generation unit that generates changes in pressure of the pressure generation chamber 13 via the vibrating plate 15. In addition, a part of the flow paths 14 forms a manifold which is a common liquid chamber of each pressure generation chamber 13. The piezoelectric element 11 is fixed to the case 16 with a fixing substrate 17 interposed therebetween, and in the vicinity of the base end portion of the piezoelectric element 11, on a surface of the piezoelectric element 11 opposite to the fixing substrate 17, a wire 18 on which a driving circuit 19 that supplies a signal for driving each piezoelectric element 11 is provided. In this ink jet recording head 10, although described later in detail, a driving signal is sent from the driving circuit on the basis of a control signal supplied from the outside to the ink jet recording head 10 via the wire 18, and the driving signal is applied to the piezoelectric element 11.

The piezoelectric element 11 expands and contracts by repeatedly charging and discharging in response to the driving signal to deform the vibrating plate 15, such that the volume of the pressure generation chamber 13 is changed. Through the change in the volume of the pressure generation chamber 13, ink droplets are discharged from predetermined nozzle openings 12.

In addition, the piezoelectric element 11 according to this embodiment is of a longitudinal vibration type formed by alternately laminating piezoelectric materials and electrode formation materials to expand and contract in the vertical direction.

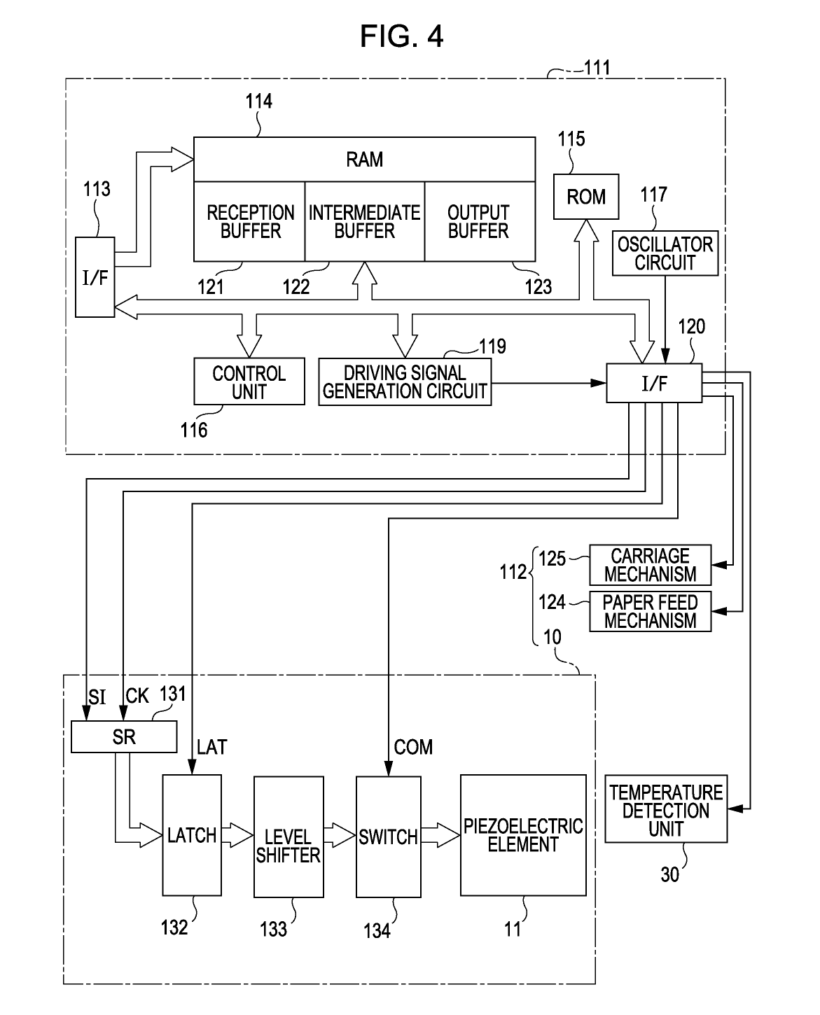

Here, a control configuration of the ink jet recording apparatus according to this embodiment will be described with reference to FIG. 4. In addition, FIG. 4 is a block diagram showing the control configuration of the ink jet recording apparatus according to the first embodiment of the invention.

The ink jet recording apparatus I according to this embodiment, as shown in FIG. 4, mainly includes a printer controller 111 and a print engine 112. The printer controller 111 includes an external interface 113 (hereinafter, referred to as an external I/F 113), a RAM 114 that temporarily stores various types of data, a ROM 115 that stores control programs and the like, a control unit 116 including a CPU or the like, an oscillator circuit 117 that generates a clock signal, a driving signal generation circuit 119 that generates a driving signal to be supplied to the ink jet recording head 10, and an internal interface 120 (hereinafter, referred to as an internal I/F 120) that transmits dot pattern data (bitmap data) or the like developed on the basis of the driving signal or printing data to the print engine 112 and receives temperature information from the temperature detection unit 30.

The external I/F 113 receives, for example, the printing data including character codes, graphic functions, image data, and the like from a host computer (not shown) or the like. A busy signal (BUSY) or an acknowledgement signal (ACK) is output to the host computer or the like via the external I/F 113. The RAM 114 functions as a reception buffer 121, an intermediate buffer 122, an output buffer 123, and a work memory (not shown). The reception buffer 121 temporarily stores the printing data received by the external I/F 113, the intermediate buffer 122 stores intermediate code data converted by the control unit 116, and the output buffer 123 stores dot pattern data. This dot pattern data is configured by printing data which can be obtained by decoding (translating) tone data.

The ROM 115 stores font data, graphic functions, and the like in addition to the control programs (control routine) for performing various data processes. The control unit 116 reads out the printing data from the reception buffer 121 and stores the intermediate code data obtained by converting this printing data in the intermediate buffer 122. The intermediate code data read out from the intermediate buffer 122 is analyzed, and the intermediate code data is developed to the dot pattern data with reference to the font data, the graphic function, and the like stored in the ROM 115. The control unit 116 performs a necessary decoration process and stores the developed dot pattern data in the output buffer 123.

When the dot pattern data corresponding to one row of the ink jet recording head 10 is obtained, this dot pattern data corresponding to one row is output to the ink jet recording head 10 via the internal I/F 120. When the dot pattern data corresponding to one row is output from the output buffer 123, the developed intermediate code data is erased from the intermediate buffer 122 and a development process of next intermediate code data is performed.

The print engine 112 includes the ink jet recording head 10, a paper feed mechanism 124, and a carriage mechanism 125. The paper feed mechanism 124 includes a paper feed motor (not shown), the platen 8 (see FIG. 1), and the like and sequentially feeds print storage media such as recording paper in response to a recording operation of the ink jet recording head 10. That is, the paper feed mechanism 124 relatively moves the print storage medium in the sub-scanning direction.

The carriage mechanism 125 includes the carriage 3 in which the ink jet recording head 10 is mounted and a carriage driving unit that moves the carriage 3 (see FIG. 1) in the main scanning direction, and moves the carriage 3 to move the ink jet recording head 10 in the main scanning direction. In addition, the carriage driving unit includes the driving motor 6, the timing belt 7, and the like as described above (see FIG. 1).

The ink jet recording head 10 has a large number of nozzle openings 12 along the sub-scanning direction and discharges ink droplets from the nozzle openings 12 at timings specified by the dot pattern data or the like. An electrical signal, for example, a driving signal (COM) which will be described later, printing data (SI), or the like is supplied to the piezoelectric elements 11 of the ink jet recording head 10 via an external wire (not shown). In the printer controller 111 and the print engine 112 having the above-described configurations, the printer controller 111, and the driving circuit 19 including a latch 132, a level shifter 133, a switch 134, and the like for selectively inputting the driving signal having a predetermined driving waveform output from the driving signal generation circuit 119 to the piezoelectric elements 11 constitute a driving unit that applies a predetermined driving signal to the piezoelectric elements 11.

The shift register 131, the latch 132, the level shifter 133, the switch 134, and each of the piezoelectric elements 11 are provided in each of the nozzle openings 12 of the ink jet recording head 10. The shift register 131, the latch 132, the level shifter 133, and the switch 134 generate a driving pulse from a discharge driving signal or a relaxation driving signal generated by the driving signal generation circuit 119. Here, the driving pulse is an applying pulse actually applied to the piezoelectric elements 11.

In the ink jet recording head 10, first, the printing data (SI) that forms the dot pattern data is serially transmitted from the output buffer 123 to the shift register 131 in synchronization with a clock signal (CK) from the oscillator circuit 117 to be sequentially set. In this case, first, data of the most significant bit in the printing data of all the nozzle openings 12 is serially transmitted, and when the serial transmission of the data of the most significant bit is completed, data of the second most significant bit is serially transmitted. In this manner, data of lower-order bits is sequentially and serially transmitted.

When the printing data of bits corresponding to all the nozzles is set in each shift register 131, the control unit 116 outputs a latch signal (LAT) to the latch 132 at a predetermined timing. By this latch signal, the latch 132 latches the printing data set in the shift register 131. The printing data (LATout) latched by the latch 132 is applied to the level shifter 133 which is a voltage amplifier. This level shifter 133 boosts the printing data up to a voltage value for driving the switch 134, for example, several tens of volts, if the printing data is, for example, “1”. The boosted printing data is applied to each switch 134 and each switch 134 enters a connected state by the printing data.

The driving signal (COM) generated by the driving signal generation circuit 119 is also applied to each switch 134, and if the switch 134 selectively enters the connected state, the driving signal is selectively applied to the piezoelectric element 11 connected to the switch 134. As such, in the exemplified ink jet recording head 10, whether or not to apply the discharge driving signal to the piezoelectric elements 11 can be controlled by the printing data. For example, since the switch 134 enters the connection state by the latch signal (LAT) in a period in which the printing data is “1”, the driving signal (COMout) can be supplied to the piezoelectric elements 11, and thus the piezoelectric elements 11 are displaced (deformed) by the supplied driving signal (COMout). In addition, since the switch 134 enters a non-connected state in a period in which the printing data is “0”, supplying the driving signal to the piezoelectric elements 11 is blocked. In addition, since the piezoelectric devices 11 hold an immediately preceding potential in the period in which the printing data is “0”, an immediately preceding displaced state is maintained.

The piezoelectric elements 11 are the longitudinal vibration-type piezoelectric elements 11 as described above. When the longitudinal vibration-type piezoelectric element 11 is used, the piezoelectric element 11 contracts in the vertical direction by charging to expand the pressure generation chamber 13, and the piezoelectric element 11 expands in the vertical direction by discharging to contract the pressure generation chamber 13. In this ink jet recording head 10, since the volume of the corresponding pressure generation chamber 13 is changed depending on the charging or the discharging of the piezoelectric element 11, the liquid droplets can be discharged from the nozzle openings 12 using the pressure change of the pressure generation chamber 13.

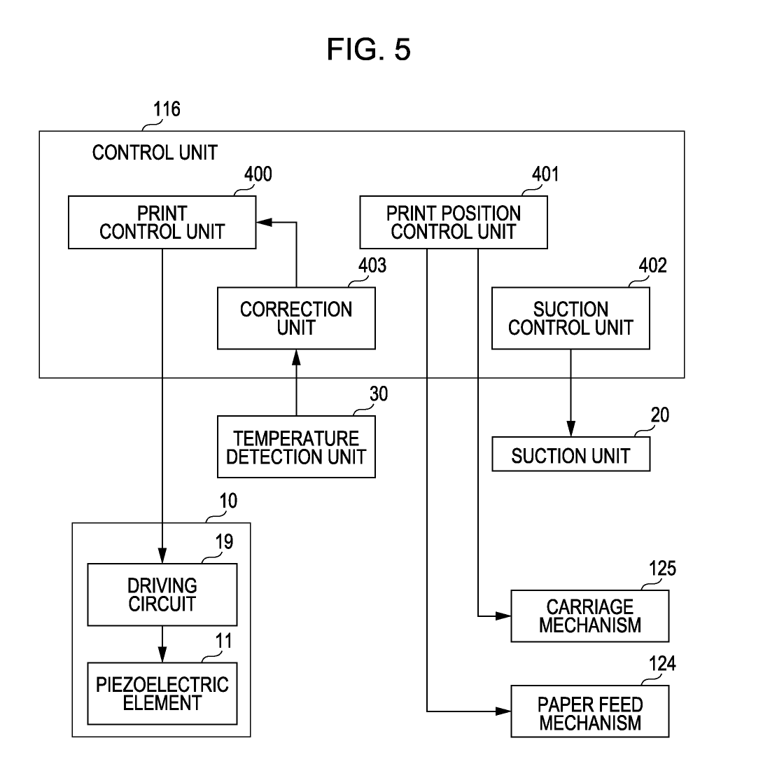

Now, the control unit 116 included in the printer controller 111 according to this embodiment will be described in detail with reference to FIG. 5. FIG. 5 is a block diagram showing a control configuration of the control unit according to this embodiment.

As shown in FIG. 5, the control unit 116 includes a print control unit 400, a print position control unit 401, a suction control unit 402, and a correction unit 403.

The print control unit 400 controls printing operations of the ink jet recording head 10, and for example, outputs the driving signal as a printing signal is input to apply the driving pulse to the piezoelectric element 11 via the driving circuit 19 provided in the ink jet recording head 10, such that ink is discharged from the ink jet recording head 10.

The print position control unit 401 performs positioning in the main scanning direction and the sub-scanning direction during printing of the ink jet recording head 10, temperature detection by the temperature detection unit 30, and a cleaning operation (a suction operation by the cap member 21, a wiping operation by blades, and the like). Specifically, as described above, the print position control unit 401 positions the ink jet recording head 10 in the main scanning direction and the sub-scanning direction by controlling the paper feed mechanism 124 and the carriage mechanism 125. In addition, the print position control unit 401 moves the recording sheet S in the sub-scanning direction while moving the carriage 3 in which the ink jet recording head 10 is mounted in the main scanning direction during printing. During the temperature detection or during the cleaning operation, the print position control unit 401 moves the carriage 3 in which the ink jet recording head 10 is mounted to the temperature detection unit 30 side (the suction unit 20 side) provided in the non-printing region. The cleaning operation mentioned here includes a suction operation of suctioning ink inside the flow paths from the nozzle openings 12 by the above-mentioned suction unit 20, and although not particularly shown, wiping of the discharge surface of the ink jet recording head 10 by blades.

The suction control unit 402 controls the suction operation of the suction unit 20. That is, the suction control unit 402 operates the suction device 23 of the suction unit 20 at a predetermined timing to perform the suction operation of suctioning ink in the vicinity of the nozzle openings 12 of the ink jet recording head 10 by the suction unit 20. Specifically, the suction control unit 402 moves the ink jet recording head 10 to the position opposing the cap member 21 using the print position control unit 401, and the ink jet recording head 10 is capped by the cap member 21 to drive the suction device 23, thereby performing the suction operation.

The correction unit 403 corrects the driving signal output by the print control unit 400 on the basis of the temperature detected by the temperature detection unit 30. Specifically, the correction unit 403 moves the ink jet recording head 10 to the position opposing the cap member 21 using the print position control unit 401. In addition, the contact portion 31 of the temperature detection unit 30 is moved to a position between the cap member 21 and the ink jet recording head 10. The correction unit 403 causes the ink jet recording head 10 to discharge ink droplets using the print control unit 400, and causes the contact portion 31 of the temperature detection unit 30 to come in contact with the discharged ink droplets. Accordingly, the temperature detection unit 30 outputs the temperature of the ink droplet that comes in contact with the contract portion 31 to the correction unit 403, and the correction unit 403 corrects the driving signal that the print control unit 400 outputs on the basis of the ink temperature information detected by the temperature detection unit 30. In practice, the correction unit 403 of the control unit 116 corrects the driving signal (driving waveform) generated by the driving signal generation circuit 119 by controlling the driving signal generation circuit 119 shown in FIG. 4.

When the actual ink temperature of the discharged ink droplet is higher than a reference temperature, the viscosity of the ink is lower than that of the reference ink, so that the correction unit 403 corrects the driving signal, for example, to reduce a driving voltage applied to the piezoelectric element 11.

On the contrary, when the actual ink temperature of the discharged ink droplet is lower than the reference temperature, the viscosity of the ink is higher than that of the reference ink, so that the correction unit 403 corrects the driving signal, for example, to increase the driving voltage applied to the piezoelectric element 11.

With regard to a reference temperature and a reference driving signal, a driving signal for driving the piezoelectric element 11 to discharge optimal ink droplets at a predetermined ink temperature is set in the ink jet recording head 10, and the temperature at which the reference driving signal is set is referred to as a reference ink temperature, and the driving signal set at the reference ink temperature is referred to as an optimal driving signal.

In a case where the ink temperature of the ink droplet actually discharged is higher than the reference ink temperature, when the piezoelectric element 11 is driven by the reference driving signal, due to the low viscosity of the ink, ink droplets cannot be discharged with optimal discharge characteristics, that is, with optimal ink weight, speed, and the like. In general, when ink with a low viscosity is discharged by driving a piezoelectric element at a relatively high driving voltage, there are problems in that the weight of ink is increased and the like. In addition, when discharge characteristics vary with the viscosity, print quality also varies. Particularly, with regard to ink having a relatively high viscosity (8 mPa·s or higher), at room temperature (about 25° C.), the viscosity of the ink significantly varies with a temperature difference of 1° C. Therefore, in this embodiment, in the case where the actual ink temperature of the discharged ink droplet is higher than the reference ink temperature, the driving voltage applied to the piezoelectric element 11 is corrected to be lower than the reference driving signal, so that the piezoelectric element 11 is driven by the driving signal that is appropriate for the actual ink temperature (viscosity). Accordingly, degradation of the ink discharge characteristics is suppressed, and variations in the discharge characteristics due to the temperature are suppressed, thereby enhancing print quality.

In the same manner, in the case where the ink temperature of the actually discharged ink droplet is lower than the reference ink temperature, when the piezoelectric element 11 is driven by the reference driving signal, due to the high ink viscosity, ink droplets cannot be discharged with optimal discharge characteristics, that is, with the optimal ink weight, speed, and the like. In general, when ink with a low viscosity is discharged by driving a piezoelectric element at a relatively low driving voltage, there are problems in that the weight of ink is reduced and the like. In addition, when the discharge characteristics vary with the viscosity, print quality also varies. Therefore, in this embodiment, in the case where the actual ink temperature of the discharged ink droplet is higher than the reference ink temperature, the driving voltage applied to the piezoelectric element 11 is corrected to be higher than the reference driving signal, so that the drive piezoelectric element 11 is driven by the driving signal that is appropriate for the actual ink temperature (viscosity). Accordingly, degradation of the ink discharge characteristics is suppressed, and variations in the discharge characteristics due to the ink temperature are suppressed, thereby reducing variations in print quality.

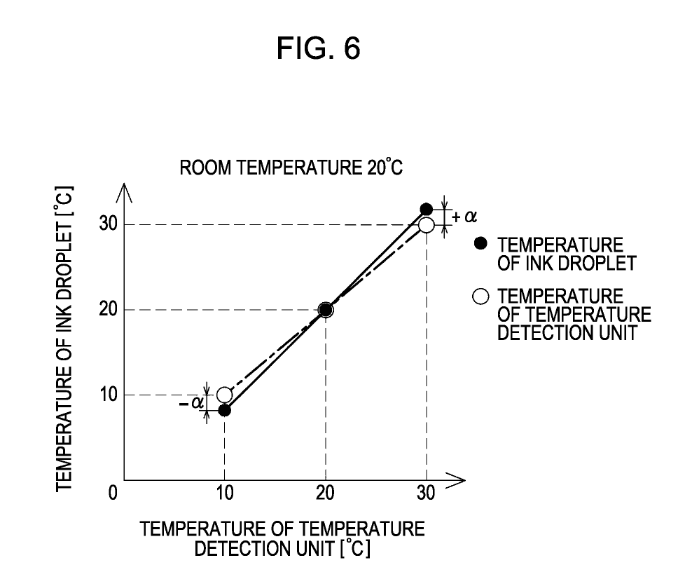

Now, a relationship between the actual ink temperature of the discharged ink droplet, the ink temperature detected by the temperature detection unit 30, and the room temperature (ambient temperature) will be described on the basis of the graph shown in FIG. 6. FIG. 6 is a graph showing the temperature of the temperature detection unit at a room temperature of 20° C. and the actual ink temperature of the ink droplet.

First, as shown in FIG. 6, at the room temperature (ambient temperature) of 20° C., when the temperature detection unit 30 detects a temperature of 20° C., the actual ink temperature of the discharged ink droplet is 20° C.

With regard to this, at the room temperature (ambient temperature) of 20° C., when the temperature detection unit 30 detects a temperature of 30° C., the actual ink temperature of the discharged ink droplet is 30+α° C. This is because as the ink droplet of 30+α° C. adheres to the contact portion 31 which is at the room temperature (20° C.), the contact portion 31 detects the temperature of 30° C. which is higher than the room temperature of 20° C. and lower than the actual ink temperature 30+α° C. In other words, when the room temperature of 20° C. is ignored, the contact portion 31 detects the temperature of the actual ink droplet of 30+α° C. However, since the room temperature is 20° C. which is lower than the temperature of the ink droplet, the contact portion 31 detects 30° C. which is lower than the ink temperature of the actual ink droplet by α° C.

On the contrary, at the room temperature (ambient temperature) of 20° C., when the temperature detection unit detects a temperature of 10° C., the ink temperature of the actually discharged ink droplet is 10−α° C. This is because as the ink droplet of 10−α° C. adheres to the contact portion 31 which is at the room temperature (20° C.), the contact portion 31 detects the temperature of 10° C. which is lower than the room temperature and higher than the temperature of the actual ink droplet of 10−α° C.

As such, the temperature detected by the temperature detection unit 30 is different from the ink temperature of the actual ink droplet due to the room temperature which is the ambient temperature. Therefore, an ambient temperature detection unit that detects the room temperature is further provided, so that the correction unit 403 corrects the temperature information detected by the temperature detection unit 30 and calculates the actual ink temperature on the basis of the temperature information detected by the temperature detection unit 30 and ambient temperature information detected by the ambient temperature detection unit. Accordingly, the correction unit 403 can accurately correct the driving signal appropriate for the actual ink temperature. That is, the correction unit 403 may correct the temperature information on the contact portion 31 detected by the temperature detection unit 30 to the temperature of the actually discharged ink droplet using the ambient temperature information on the ambient temperature, and correct the driving signal on the basis of the corrected temperature information. Of course, a correction table for the driving signal in which errors of the actual temperature of the ink droplet from the ambient temperature are included may be provided, and the correction unit 403 may directly correct the driving signal from the temperature information detected by the temperature detection unit 30 on the basis of the correction table.

Alternatively, without the ambient temperature detection unit, the temperature detection unit 30 may function as the ambient temperature detection unit that detects the ambient temperature. That is, in a state where the ink droplet does not adhere to the temperature detection unit 30, the temperature detection unit 30 detects the room temperature which is the ambient temperature, so that the temperature of ink droplet can be actually calculated by measuring a temperature change amount before and after the ink droplet adheres.

In order for the temperature detection unit 30 to detect the temperature of the discharged ink droplet, ink droplets may be discharged from the plurality of nozzle openings 12 to the temperature detection unit 30. Otherwise, in order for the temperature detection unit 30 to detect the temperature of the ink droplet, a plurality of ink droplets may be discharged from a single nozzle opening 12 to come in contact with the contact portion 31.

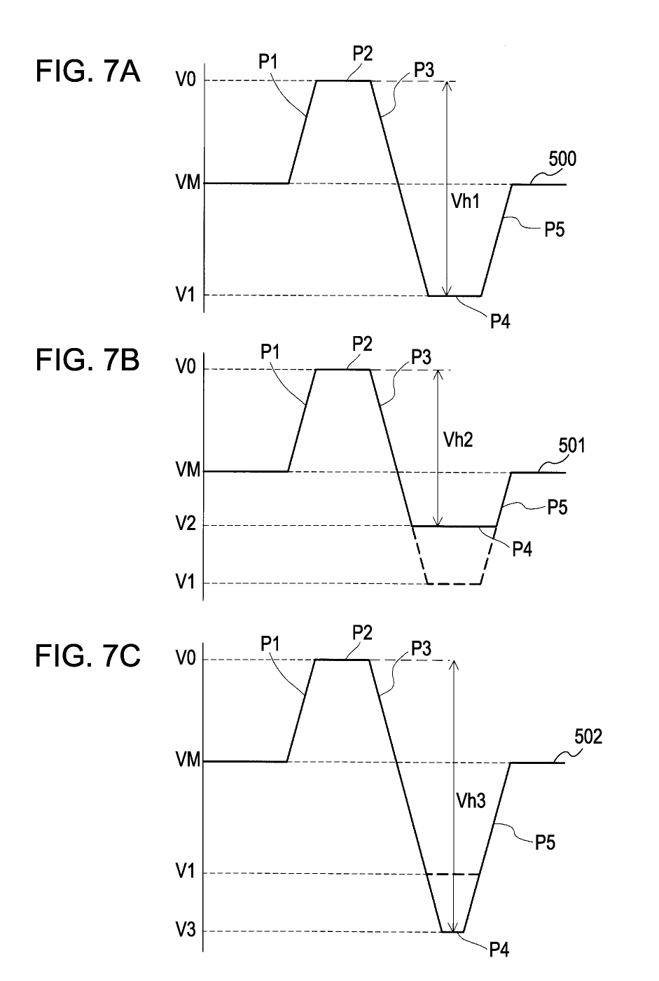

Here, the driving waveform that represents the driving signal (COM) of this embodiment input to the piezoelectric element 11 will be described. FIGS. 7A to 7C are driving waveform diagrams showing the driving signals according to this embodiment. In addition, the driving waveform input to the piezoelectric element 11 is applied to an individual electrode using a common electrode as a reference potential (0V in this embodiment).

First, the driving waveform that represents the reference driving signal will be described. As shown in FIG. 7A, the reference driving waveform 500 includes a first voltage change step P1 for increasing from a state in which an intermediate potential VM is held to a first potential V0 to expand the pressure generation chamber 13, a first hold step P2 for holding the first potential V0 for a predetermined time, a second voltage change step P3 for decreasing from the first potential V0 to a second potential V1 (driving voltage Vh1) to contract the pressure generation chamber 13, a second hold step P4 for holding the second potential V1 for a predetermined time, and a third voltage change step P5 for increasing from the second potential V1 to the intermediate potential VM to expand the pressure generation chamber 13. When such a driving waveform is output to the piezoelectric element 11, the piezoelectric element 11 is deformed in a direction in which the volume of the pressure generation chamber 13 expands by the first voltage change step P1, and the meniscuses in the nozzle openings 12 are drawn into the pressure generation chamber 13. Thereafter, the piezoelectric element 11 is deformed in a direction in which the volume of the pressure generation chamber 13 contracts, by the second voltage change step P3, such that the meniscuses in the nozzle openings 12 are greatly pushed from the pressure generation chamber 13 side, and ink droplets are discharged from the nozzle openings 12. That is, this driving waveform is of a pull-push type.

In the case where the actual ink temperature (the temperature corrected using the room temperature) of the ink droplet detected by the temperature detection unit 30 is higher than the temperature of the ink set by this reference driving signal (the driving waveform 500), as shown in FIG. 7B, a driving waveform 501 includes the first voltage change step P1 for increasing from the state in which the intermediate potential VM is held to the first potential V0 to expand the pressure generation chamber 13, the first hold step P2 for holding the first potential V0 for a predetermined time, the second voltage change step P3 for decreasing from the first potential V0 to a third potential V2 (driving voltage Vh2) which is a potential higher than the second potential V1 (a potential at which a potential difference Vh2 from the first potential V0 is smaller than Vh1) to contract the pressure generation chamber 13, the second hold step P4 for holding the third potential V2 for a predetermined time, and the third voltage change step P5 for increasing from the third potential V2 to the intermediate potential VM to expand the pressure generation chamber 13.

When this driving waveform 501 is applied to the piezoelectric element 11, the driving voltage Vh2 which is lower than the driving voltage Vh1 of the reference driving waveform 500 is applied to the piezoelectric element 11, so that a force to discharge ink droplets is weakened compared to a typical force.

In addition, contrary to the temperature of the ink set by the reference driving signal (the driving waveform 500), in the case where the actual temperature (a temperature corrected using the room temperature) of the ink droplet detected by the temperature detection unit 30 is low, as shown in FIG. 7C, a driving waveform 502 includes a first voltage change step P1 for increasing from the state in which the intermediate potential VM is held to the first potential V0 to expand the pressure generation chamber 13, the first hold step P2 for holding the first potential V0 for a predetermined time, the second voltage change step P3 for decreasing from the first potential V0 to a fourth potential V3 (driving voltage Vh3) which is a potential lower than the second potential V1 (a potential at which a potential difference Vh3 from the first potential V0 is greater than Vh1) to contract the pressure generation chamber 13, the second hold step P4 for holding the fourth potential V3 for a predetermined time, and the third voltage change step P5 for increasing from the fourth potential V3 to the intermediate potential VM to expand the pressure generation chamber 13.

When this driving waveform 502 is applied to the piezoelectric element 11, the driving voltage Vh3 which is higher than the driving voltage Vh1 of the reference driving waveform 500 is applied to the piezoelectric element 11, so that a force to discharge ink droplets is strengthened compared to a typical force.

However, when the force to discharge ink droplets is changed as represented by the driving waveforms 500 to 502, the flying speed of the ink droplet is changed with the magnitude of the force. For example, like the driving voltage Vh2 of the driving waveform 501, when the driving voltage is set to be greater than the reference driving voltage Vh1, the flying speed of the ink droplet becomes higher than the flying speed with the reference driving waveform 500. On the contrary, like the driving voltage Vh3 of the driving waveform 502, when the driving voltage is set to be smaller than the reference driving voltage Vh1, the flying speed of the ink droplet becomes lower than the flying speed with the reference driving waveform 500.

Although not shown by the above-described driving waveforms 500 to 502, it is preferable that the shapes of the driving waveforms 500 to 502 be corrected so that the flying speed of the ink droplet is set to the speed (standard speed) with the reference driving signal.

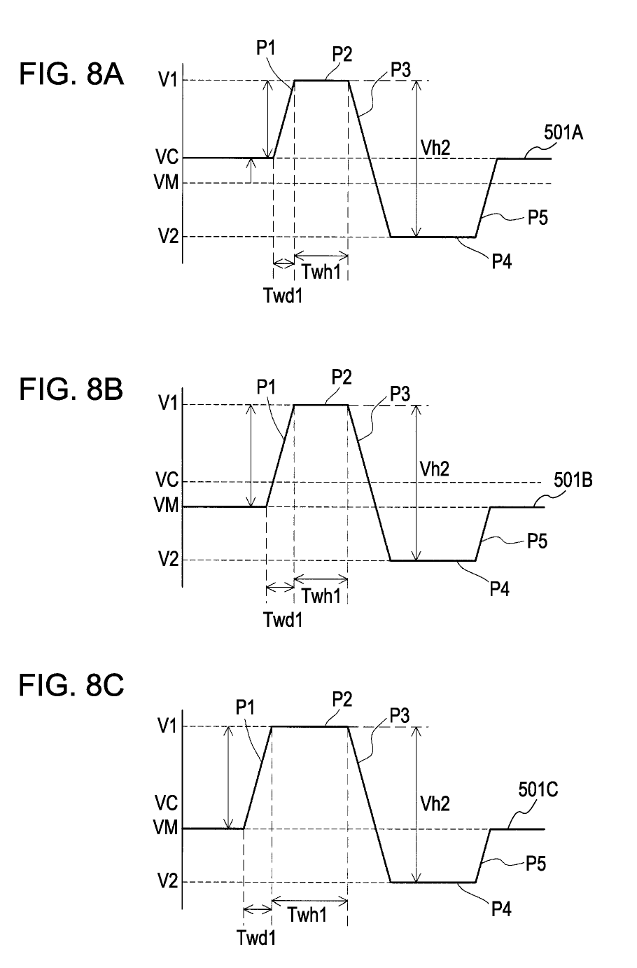

For example, like the driving waveform 501, when the driving voltage Vh2 is set to be higher than the driving voltage Vh1 of the reference driving waveform 500, correction of driving waveforms 501A to 501C exemplified with FIGS. 8A to 8C is performed to suppress the flying speed of the ink droplet. That is, in the driving waveform 501A of FIG. 8A, an intermediate potential VC is increased by raising the intermediate potential VC to be higher than the reference intermediate potential (the intermediate potential VM of the driving waveform 501 of FIG. 7B). In addition, in the driving waveform 501B of FIG. 8B, a voltage gradient of a first voltage change step P1 for expanding the pressure generation chamber 13 is set to be gentle. In other words, a supply time Twd1 of the first voltage change step P1 is set to be longer than that of the standard (the driving waveform 501 shown in FIG. 7B). Moreover, in the driving waveform 501C of FIG. 8C, a first hold step P2 (a time component Twh1) for maintaining the expanding state of the pressure generation chamber 13 is set to be longer than that of the standard (the driving waveform 501 shown in FIG. 7B).

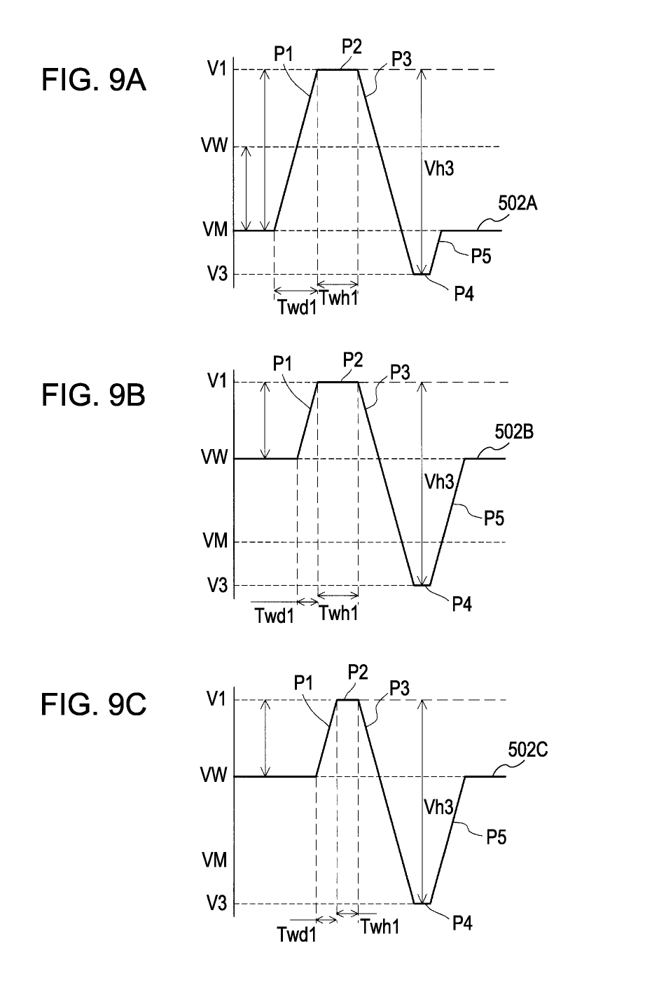

On the other hand, like the driving waveform 502, in the case where the driving voltage Vh3 is set to be lower than the driving voltage Vh1 of the reference driving waveform 500, the correction of the driving waveforms 502A to 502C exemplified in FIGS. 9A to 9C is performed to increase the flying speed of the ink droplet. That is, in the driving waveform 502A of FIG. 9A, the intermediate potential VC is increased by raising the intermediate potential VC to be higher than the reference intermediate potential (the intermediate potential VM in the driving waveform 502 of FIG. 7C). In the driving waveform 502B of FIG. 9B, a voltage gradient of the first voltage change step P1 for expanding the pressure generation chamber 13 is set to be steep. In other words, the supply time Twd1 of the first voltage change step P1 is set to be shorter than that of the standard. In the driving waveform 502C of FIG. 9C, the first hold step P2 (the time component Twh1) for maintaining the expanding state of the pressure generation chamber 13 is set to be shorter than that of the standard (the driving waveform 502 shown in FIG. 7C).

By correcting the driving waveform 500 that represents the driving signal to the driving waveforms 501A to 501C and 502A to 502C according to the actual ink temperature as described above, ink droplets can be discharged always with constant ink weight and speed regardless of a change in ink temperature, so that variations in print quality can be suppressed and the print quality can be enhanced.

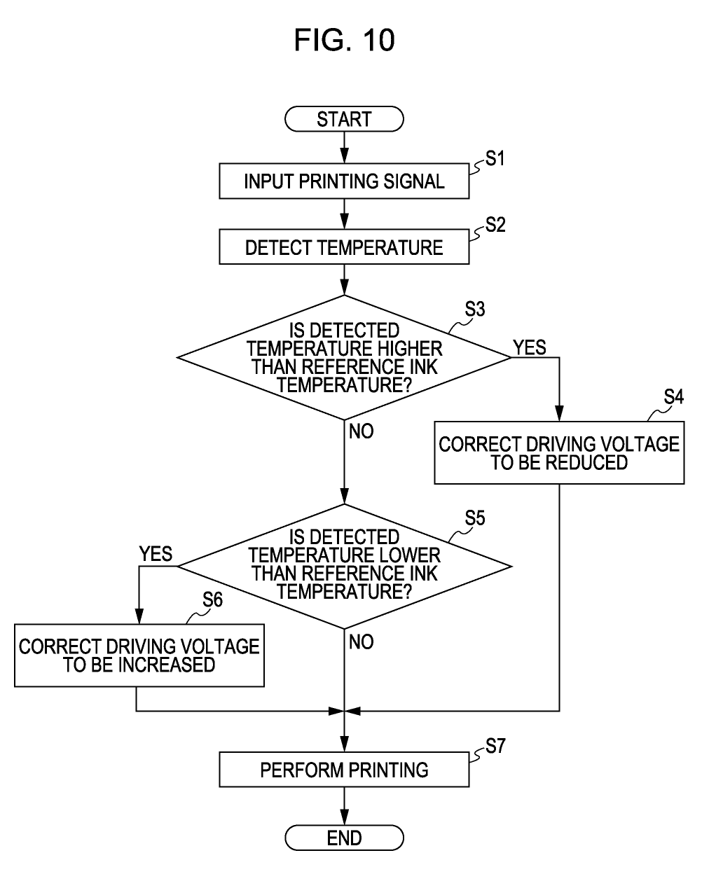

Here, the operations of the ink jet recording apparatus I according to the first embodiment of the invention will be further described in detail. FIG. 10 is a flowchart of the operations of the ink jet recording apparatus according to the first embodiment of the invention.

As shown in FIG. 10, when the printing signal is input in Step S1, ink droplets are caused to come in contact with the temperature detection unit in Step S2 to measure the ink temperature. Specifically, as described above, the print position control unit 401 of the control unit moves the ink jet recording head 10 to the position opposing the cap member 21 in the non-printing region, and ink droplets are discharged from the ink jet recording head 10 by the print control unit 400 and adhere to the temperature detection unit 30 (the contact unit 31). Here, at the same time, the room temperature (ambient temperature) is detected by the ambient temperature detection unit, and the control unit 116 calculates the actual ink temperature of the discharged ink droplet. In addition, the temperature information detected by the temperature detection unit 30 or the ambient temperature detection unit is input to the correction unit 403 of the control unit 116.

Next, in Step S3, whether or not the detected actual temperature of the ink droplet (the actual ink temperature corrected using the ambient temperature) is higher than the reference ink temperature is determined, and if the detected temperature of the ink droplet is higher than the reference ink temperature (Yes in Step S3), the control unit corrects the reference driving signal to the driving signals shown in FIG. 7B or FIGS. 8A to 8C (the driving waveforms 501A to 501C) in Step S4, and printing is performed using the corrected driving signal in Step S7. Accordingly, even when the ink temperature is higher than the reference temperature, ink droplets can be discharged with the same ink discharge characteristics (ink weight and flying speed) as those of the driving signal set at the reference temperature.

In addition, if the detected temperature of the ink droplet is not higher than the reference ink droplet temperature in Step S3 (No in Step S3), whether or not the detected ink temperature of the ink droplet (the actual ink temperature corrected using the ambient temperature) is lower than the reference ink temperature is determined in Step S5. If the detected temperature of the ink droplet is lower than the reference ink temperature in Step S5 (Yes in Step S5), the control unit corrects the reference driving signal to the driving signals shown in FIG. 7C or FIGS. 9A to 9C (the driving waveforms 502A to 502C) in Step S6, and printing is performed by the driving signal corrected in Step S7. Accordingly, even when the ink temperature is lower than the reference temperature, ink droplets can be discharged with the same ink discharge characteristics (ink weight and flying speed) as those of the driving signal set at the reference temperature.

If the detected temperature of the ink droplet is not lower than the reference ink droplet temperature in Step S5 (No in Step S5), since the detected ink temperature of the ink droplet is the same as the reference ink temperature, printing is performed by the reference driving signal (the driving waveform 500) shown in FIG. 7A in Step S7.

As such, the driving signal is corrected according to the actual ink temperature of the discharged ink droplets detected by the temperature detection unit 30 to uniformize the discharge characteristics of the ink droplet, thereby enhancing the print quality.

Particularly, since ink having a relatively high viscosity (of 8 mPa·s or higher) at room temperature (about 25° C.) significantly varies in viscosity with a temperature difference of 1° C., correction of the driving signal is performed as described above for the ink jet recording head 10 that discharges ink having a relatively high viscosity (of 8 mPa·s or higher at a room temperature of 25° C.), thereby exhibiting excellent effects.

Although a series of operations from detection of temperature in Step S2 to performing of printing in Step S7 has been described, the detection of temperature of Step S2 and correction of the driving signal in Steps S3 and S5 may be performed every predetermined time during printing. In general, in an ink jet recording apparatus, at predetermined intervals before starting printing or during printing, a preliminary discharge operation (flushing) for discharging ink droplets to the non-printing region is performed. The flushing is to discharge ink inside nozzle openings and nearby by discharging ink droplets in a state where the ink jet recording head 10 is stopped, for example, at a standby position in the non-printing region which is outside the region where the ink jet recording head 10 opposes the recording sheet S, at a predetermined time, for example, before starting printing or between printing operations, in order to solve a problem in which the viscosity of ink is increased due to a change in ink temperature caused by a change in ambient temperature and clogging of the nozzle openings occurs. The ink droplets discharged by the flushing may be caused to come in contact with the contact portion 31 to perform temperature detection. Accordingly, unnecessary consumption of ink can be reduced. In addition, although not limited to the flushing, by performing temperature detection or correction of the driving signal between printing operations, a change in ink temperature between the printing operations can be coped with, thereby further enhancing the print quality.

As such, in this embodiment, ink droplets are discharged from the ink jet recording head 10, the ink temperature of the discharged ink droplet is detected, and the driving signal is corrected on the basis of the detected ink temperature information. Accordingly, a sensor or the like is not provided in the flow path 14 inside the ink jet recording head 10, so that an increase in the size of the head or an increase in costs can be suppressed.

In addition, since the temperature of the actually discharged ink droplet is detected, the temperature of the discharged ink other than the temperature of ink that is far from the nozzle openings 12, such as, in the manifold of the flow paths 14 can be detected, thereby correcting the driving signal appropriately for the actual ink temperature. Accordingly, the print quality can further be enhanced.

### Other Embodiments

While the embodiments of the invention have been described, the basic configuration of the invention is not limited to the above-described configurations.

For example, in the first embodiment described above, as the pressure generation unit that causes a change in the pressure of the pressure generation chamber 13, the vertical vibration-type actuator device which is formed by alternately laminating piezoelectric materials and electrode formation materials to expand and contract in the axial direction is used. However, the pressure generation unit is not particularly limited to this, and for example, a flexural vibration-type actuator device such as a thin film-type formed by laminating electrodes and piezoelectric materials using film formation or lithography, or a pressure membrane-type formed by a method of attaching a green sheet or the like may be used as the pressure generation unit. In addition, as the pressure generation unit, a device in which heat generating elements are disposed in pressure generation chambers and liquid droplets are discharged from nozzle openings by bubbles generated by heat generation of the heat generating elements, or a so-called electrostatic actuator that generates static electricity between a vibrating plate and electrodes and discharges liquid droplets from nozzle openings by deforming the vibrating plate by electrostatic force may be used.

In addition, although the ink jet recording head 10 (the head units 1A and 1B) in the ink jet recording apparatus I of the above-described first embodiment is mounted in the carriage 3 and is moved in the main scanning direction, the invention is not particularly limited to this. For example, the invention may be applied to a so-called line type recording apparatus in which the ink jet recording head 10 is fixed such that printing is performed by moving only a recording sheet S such as paper in the sub-scanning direction.

In addition, in the above-described first embodiment, the ink jet recording head is exemplified as the liquid ejecting head. However, the invention relates to liquid ejecting heads in general and can be applied to a liquid ejecting head that ejects liquid other than ink. As other liquid ejecting heads, for example, various recording heads used for image recording apparatuses such as printers, coloring material ejecting heads used for manufacturing color filters of liquid crystal displays and the like, electrode material ejecting heads used for forming electrodes of organic EL displays, field emission displays (FEDs), and the like, bio-organic matter ejecting heads used for manufacturing biochips, and the like may be employed.

The entire disclosure of Japanese Patent Application No. 2010-157636, filed Jul. 12, 2010 is expressly incorporated by reference herein.

What is claimed is:

1. A liquid ejecting apparatus comprising:
a liquid ejecting head that includes nozzle openings through which liquid is ejected and pressure generation units that cause changes in pressure of the liquid inside pressure generation chambers communicating with the nozzle openings;
a control unit that supplies a driving signal for causing the liquid ejecting head to eject the liquid, to the pressure generation units, and controls ejection of the liquid by the liquid ejecting head; and
a temperature detection unit that has a contact portion with which the liquid ejected by the liquid ejecting head comes in contact and detects a temperature of the contact portion,
wherein the control unit corrects the driving signal on the basis of the temperature information detected by the temperature detection unit.

2. The liquid ejecting apparatus according to claim 1,
wherein the control unit corrects the driving signal so as to apply a higher voltage than a reference voltage applied to the pressure generation unit by the driving signal, when the detected temperature information represents a temperature lower than a reference temperature, and
the controller corrects the driving signal so as to apply a lower voltage than the reference voltage applied to the pressure generation unit by the driving signal, when the detected temperature information represents a temperature higher than the reference temperature.

3. The liquid ejecting apparatus according to claim 1, further comprising an ambient temperature detection unit that measures an atmospheric temperature of the liquid ejecting head,
wherein the control unit corrects the temperature information using a difference between the temperature information detected by the temperature detection unit and ambient temperature information detected by the ambient temperature detection unit, and corrects the driving signal on the basis of the corrected temperature information.

4. The liquid ejecting apparatus according to claim 1, wherein the contact portion is provided with a water-repellent film that repels the liquid ejected from the liquid ejecting head.

5. The liquid ejecting apparatus according to claim 1, wherein the liquid ejecting head ejects liquid having a viscosity of 8 mPa·s or higher.

6. A control method of controlling a liquid ejecting head which includes nozzle openings through which liquid is ejected, pressure generation chambers communicating with the nozzle openings, and pressure generation units that cause changes in pressure of the liquid inside pressure generation chambers, comprising:
detecting a temperature of the liquid ejected by the liquid ejecting head; and
correcting a driving signal of the pressure generation unit of the liquid ejecting head on the basis of the detected temperature information.
